(19) United States
(12) Patent Application Publication
(10) Pub. No.: US 2006/0148672 A1
(43) Pub. Date: Jul. 6, 2006

(54) Process for releasing fragrance

(75) Inventors: Yasuhiro Shidahara, Wakayama (JP); Koichi Ohori, Wakayama (JP); Jun Kozuka, Wakayama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Tokyo (JP)

(21) Appl. No.: 10/546,208

(22) PCT Filed: May 26, 2004
(86) PCT No.: PCT/JP04/07540

§ 371 Date: Aug. 18, 2005

(30) Foreign Application Priority Data
May 28, 2003 (JP) 2003-151441

(51) Int. Cl. A61Q 13/00

(52) U.S. Cl. 512/1

(57) ABSTRACT

A process for releasing fragrance comprising the step of treating a) a perfume emulsified with one or more substances having emulsification actions, with b) demulsifying agent capable of demulsifying at least one of the substances having emulsification actions.

### FIELD OF THE INVENTION

The present invention relates to a process for releasing fragrance, a perfume composition, a detergent composition and a process for preparing the detergent composition.

### BACKGROUND OF THE INVENTION

Conventionally, perfumes have been used for the purpose of perfuming various foods, detergents, cosmetics, bathing agents and the like, and the elevation in their commercial value has been widely carried out by deodorizing odors owned by the raw materials and releasing a fragrance comfortable for consumers. Various methods have been so far disclosed as a perfuming method, and a direct perfuming method including the step of spraying a perfume with a spray or the like is generally employed in the case of, for instance, manufactured articles in the forms of powders and solids. As other perfuming methods, for instance, Japanese Patent Publication No. 2001-521060 discloses a method including the steps of allowing a perfume to be oil-absorbed to a certain carrier, optionally adding a binder thereto, and compressing, extruding or the like such mixture; Japanese Patent Laid-Open Nos. Sho 50-35072 and Hei 11-140482 each discloses a method including the step of emulsifying a perfume as an oil in water containing a dissolved water-soluble matrix agent and drying the emulsion, resulting in perfume particles encapsulated in the water-soluble matrix.

The direct perfuming method which is the most general method is excellent from the viewpoint of deodorization of the odors owned by raw materials. However, there are problems such as it is difficult to formulate a perfume having low stability against contact with a substance contained in the composition, and the dissipation of perfume occurs constantly from the moment of perfuming, so that the perfume tone is lost and the fragrance has disappeared during long-term storage. In addition, in the method for molding a perfume disclosed in Japanese Patent Publication No. 2001-521060, the perfume is not completely encapsulated even though there are some effects of suppressing the dissipation of perfume to a certain extent, so that the perfuming method has not yet been attained to a level sufficient to keep the perfume stable for long-term storage.

On the other hand, in the techniques disclosed in Japanese Patent Laid-Open Nos. Sho 50-35072 and Hei 11-140482, it is considered that perfume particles retain perfume in a water-soluble matrix in the form of a capsule, thereby providing high storage stability. However, since a stable emulsion durable in the emulsification and drying steps is necessary so that the perfume is present in the form of an emulsion prepared in the emulsification step, there are some problems such as the fragrance is released in a lower amount during dissolution when dissolved during use, and the ability to sustain a fragrance for a certain object is lowered when the object is perfumed by such an operation. Consequently, there is a defect that the property owned by the perfume itself cannot be satisfactorily exhibited.

### SUMMARY OF THE INVENTION

The present invention relates to:

[1] a process for releasing perfume including the step of treating

a) a perfume emulsified with one or more substances having emulsification actions, with
b) a demulsifying agent capable of demulsifying at least one of the substances having emulsification actions;
   [2] a perfume composition containing:
a) a perfume emulsified with one or more substances having emulsification actions, and
b) a demulsifying agent capable of demulsifying at least one of the substances having emulsification actions;
   [3] a detergent composition containing the above perfume composition; and
   [4] a process for preparing a detergent composition including the step of carrying out direct perfuming to the above perfume composition or the above detergent composition.

### BRIEF DESCRIPTION OF THE DRAWINGS

FIG. 1 shows a SEM image of a cross section of perfume particle 6 obtained in the Example, wherein pores observed on the cross section show oil droplets of a perfume, from which it can be seen that a large number of oil droplets are dispersed in the perfume particles.

### DETAILED DESCRIPTION OF THE INVENTION

The present invention relates to a process for releasing fragrance, a perfume composition, a detergent composition and a process for preparing the detergent composition, which, for instance, suppress dissipation of perfume before use, are excellent in a long-term storage stability, and allow the properties of a perfume to be satisfactorily exhibited upon use.

As a result of intensive studies, the present inventors have found that in a technique of encapsulating perfume in a water-soluble matrix, a combination of a substance having a certain kind of emulsification action with a demulsifying agent allows the properties of the perfume itself to be satisfactorily exhibited upon use, while suppressing the dissipation before use. The present invention has been perfected thereby.

Therefore, by using the process for releasing fragrance of the present invention, some effects that powders, solid manufactured articles or the like for, for instance, detergents, bathing agents, foods, beverages and the like, can be produced, which, for instance, suppress the dissipation of perfume before use, have excellent long-term storage stability, and moreover allow the properties of a perfume to be sufficiently exhibited upon use, are exhibited.

One feature of the process for releasing a fragrance of the present invention resides in that the process includes the step of treating a perfume (hereinafter also referred to as component a)) emulsified with one or more substances having emulsification actions (hereinafter simply referred to as an emulsification action substance), with a demulsifying agent (hereinafter also referred to as component b)) for demulsifying at least one of the emulsification action substances.

By using the process for releasing a fragrance of the present invention having the above feature, excellent effects are exhibited such as the dissipation of a perfume before use is suppressed, long-term storage stability of the perfume is excellent, and moreover the properties of the perfume can be sufficiently exhibited upon use.

Particularly, in the present invention, by using a combination of an emulsification action substance with a demulsifying agent for demulsifying the emulsification action substance, effects are exhibited such as a perfume is released upon use while maintaining stability durable for the emulsification and drying steps, potential of the perfume itself can be satisfactorily exhibited, and perfuming with suppressed dissipation during storage can be realized.

Further, according to the present invention, the formulation of a certain perfume which has been difficult to formulate using conventional techniques from the viewpoint of stability, and the increase in the upper limit of the perfume formulation amount which has been limited from the viewpoint of bleed-out property and the like can be realized. Also, a system for releasing fragrance which has not so far been found, which is capable of changing the state of powders and solids before use, generation of fragrance upon use, perfume tone of the remaining fragrance on an object and its strength can be realized by combining the present invention with a known perfuming method.

The present invention will be described in detail hereinbelow.

[Component a)]

In the present invention, as component a), a perfume emulsified with one or more emulsification action substances is used.

The process for releasing fragrance of the present invention can be used in various industrial fields. Among them, the process is preferably used in the fields of various foods, detergents, cosmetics and bathing agents in which demand for perfume is high. Especially, the process is suitably used in the field of detergents from the viewpoint of the existence of a variety of usable kinds of perfume.

The emulsification action substance usable in the present invention is not particularly limited, and includes any emulsifying agents and the like. When one kind of the emulsification action substance is used in the composition of the present invention, the emulsification action substance is required to be a substance having an agent (demulsifying agent) for demulsifying the emulsification action substance in its an emulsification system. On the other hand, when two or more emulsification action substances are used in the composition of the present invention, it is necessary that at least one emulsification action substance having the corresponding demulsifying agent is contained.

Here, the emulsification action substance involves any substances capable of forming an emulsion state (showing a state of forming a relatively stable system in which in two liquids not easily dissolved into each other, one constitutes a continuous phase and the other constitutes a dispersed phase in the form of fine particles), in addition to general emulsifying agents.

Examples of the emulsification action substance include cellulose-based emulsification action substances demulsified with cellulase such as cationated celluloses, methyl cellulose, carboxymethyl cellulose, metal salts thereof and hydroxypropylmethyl cellulose; protein-based emulsification action substances demulsified with protease such as sodium salt of casein, milk protein and soybean protein; starch-based emulsification action substances demulsified with amylase such as cationated starches, esterified processed starches such as octenylsuccinate starch and sucrose fatty acid esters; emulsification action substances demulsified by pH adjustment with an alkali or an acid, or changing salt strength with an electrolyte or the like, such as polyoxyalkylene-based nonionic surfactants, and sucrose fatty acid esters. Particularly, when used for a detergent composition formulation, cellulose-based and protein-based emulsification action substances demulsified with an enzyme or an alkali having a deterging action are advantageous, since the enzyme or the alkali used together as a demulsifying agent can also exhibit a deterging action. Among them, cationated celluloses, methyl cellulose and sodium salt of casein and the like are preferable. These emulsification action substances can be used alone or in combination of two or more. In the present invention, when two or more emulsification action substances are used, a combination thereof is not particularly limited, so long as one or more emulsification action substances to be demulsified with a demulsifying agent described later are contained.

The amount of the emulsification action substance used varies depending on the kinds and amounts of perfume to be added, the kinds of the emulsification action substance and the like. The amount is not particularly limited, so long as a stable emulsion being durable for the emulsification and drying steps is obtained. The typical amount used is preferably from 0.001 to 1 part by weight, more preferably from 0.01 to 0.5 part by weight, based on 1 part by weight of a perfume described later. When two or more kinds of the emulsification action substances are used, the amount of the emulsification action substance used to be demulsified is preferably 10% by weight or more, more preferably 50% by weight or more of all of the emulsification action substances.

In component a) used in the present invention, the state of the perfume emulsified with the above emulsification action substance is not particularly limited. Particularly, it is preferable to disperse and immobilize a perfume in the form of an oil droplet with the above emulsification action substance to form perfume particles and to use the perfume particles as component a), from the viewpoints of suppression of the dissipation before use and its excellent long-term storage stability.

In the present invention, the term “dispersing and immobilizing” refers to a state in which oil droplets are immobilized in the form of fine liquid droplets in a matrix formed by a compound forming matrix.

As the perfume which can be used in the present invention, any compounds can be used depending on its purpose. The perfume includes, for instance, natural perfumes, synthetic perfumes and mixed perfumes obtained by mixing the natural perfumes and the synthetic perfumes. These may contain components other than perfumes, such as a solvent.

For instance, when the present invention is used for a powder detergent, the perfume includes natural perfumes such as grapefruit oil, rose oil, and aroma oil, synthetic perfumes such as limonene, menthol, citronellol, jasmone, and pentalide, mixed perfumes prepared by mixing the natural perfumes and the synthetic perfumes, and the like.

The amount of the perfume in component a) is preferably from 5 to 70% by weight, more preferably from 10 to 50% by weight, from the viewpoints of suppression of the dissipation, improvement in the immobilization ratio and decrease in the preparation costs.

In addition, when component a) is prepared, it is preferable to add a matrix-forming agent as a compound for dispersing and immobilizing a perfume in the form of an oil droplet. As the matrix-forming agent, any compound can be used so long as the compound is a substance which is water soluble and has a matrix-forming ability. The matrix-forming agent includes processed starches, modified starches, gelatin-degraded substances, agar, sodium salt of carboxymethyl cellulose and the like. Among them, dextrin and hydrolyzed dextrin such as maltodextrin, and starch derivatives such as esterified starches and etherified starches are preferable from the viewpoint of the density of the matrix formed. When a hydrolyzed starch is used, the lower the degree of hydrolysis, DE value, the better since the encapsulated state becomes favorably excellent. However, ones having a lower DE value tend to show lower solubility, so that it is necessary to adjust the DE value depending upon the desired solubility for a perfume composition. Therefore, a DE value of from 5 to 15 is preferable, giving an excellent balance between encapsulation property and solubility.

The above emulsification action substance may function as a matrix-forming agent, and the matrix-forming agent may function as the above emulsification action substance, so that they perform an overlap in their functions, in some cases.

The amount of the matrix-forming agent in component a) is preferably from 10 to 90% by weight, more preferably from 20 to 80% by weight, from the viewpoints of suppression of the dissipation, improvement in the immobilization ratio and decrease in the preparation costs.

In addition, optional components which may be contained in component a) include film strength-controlling agents such as polyhydric alcohols, saccharides and carrageenan, and colorants such as pigments and dyes.

The amount of these optional components in component a) is preferably from 0 to 20% by weight, more preferably from 0 to 10% by weight from the viewpoint of not hindering the matrix formation.

It is preferable that the perfume particles having the composition as described above [component a)] are obtained in the form of powder by emulsifying a perfume with an emulsification action substance, and thereafter drying the emulsion, from the viewpoints of productivity and uniformity of the composition. The preferred preparation process is, for instance, a process including the following steps, without intending to limit the present invention to this process.

(1) Emulsification Step

The above matrix-forming agent is dispersed or dissolved in water which is appropriately temperature-controlled, an emulsification action substance and a perfume are added thereto, and the mixture is emulsified with a known means such as a homomixer or a line mixer, to form an emulsion.

(2) Drying Step

Next, the emulsion obtained is spray-dried by a known means, resulting in perfume particles in which perfume components are encapsulated in a water-soluble matrix.

(3) Processing Step (Optional Step)

The resulting perfume particles can also be subjected to a secondary process according to its purposes. The secondary process includes, for instance, removal of fine powders and coarse granules by sieving, processing of particle size and shape by a granulation and molding procedures, coloration with pigments and dyes, and the like.

The shape and size of the perfume particles obtained by the above process (after the drying step) are not particularly limited, and its size (average particle size) is preferably from 10 to 5000 μm, more preferably from 100 to 1000 μm, from the viewpoints of treatment capacity in the drying step and handling property of the resulting particles.

The median diameter measured by a laser diffraction/scattering type particle size distribution analyzer LA-920 (commercially available from HORIBA, Ltd.) is used as an average powder particle size (particle size of the perfume particles after the drying step) or an average particle size of the emulsified perfume (particle size of emulsified perfume before the drying step). As the dispersion medium, ethanol is used for the determination of a powder particle size, and water is used for the determination of a particle size of the emulsified perfume.

In the case of the determination of the particle size of the emulsified perfume, the emulsified perfume is adjusted to a given concentration, and thereafter the emulsified dispersion diameter is determined. In the case of the determination of a powder particle size, the powder is irradiated with an ultrasonic wave of intermediate level (specifically, 4 of 7 stages of the analyzer LA-920) for 1 minute, and the dispersion diameter is determined. When the powder particle size determined with LA-920 is 100 μm or more, the determination is carried out by a Ro-Tap method.

[Component b)]

In the process for releasing fragrance of the present invention, component a) is treated with a demulsifying agent [component b)] as described above. In the present invention, by using component b), there is an advantage of satisfying two requirements, which are usually incompatible to each other, of obtaining a stable emulsified perfume durable for preparation in the emulsification and drying steps, and efficiently releasing a perfume during use.

The demulsifying agent usable in the present invention refers to an agent having an action of demulsifying at least one of the emulsification action substances in the above component a). Examples of the demulsifying agent include enzymes, alkalis, acids, electrolytes and the like, and at least one member selected from the group consisting of these demulsifying agents is suitably used. The enzyme includes cellulase, protease, amylase, lipase and the like. The alkali includes sodium carbonate, potassium carbonate, sodium hydroxide, potassium hydroxide and the like. The acid includes succinic acid, fumaric acid, phthalic acid, citric acid and the like. The electrolyte includes sodium sulfate, sodium chloride and the like in addition to the above alkalis. Among them, the enzymes are preferable, and cellulase and protease are more preferable from the viewpoint of obtaining a demulsification effect by addition in a small amount. These components b) may be used alone or in combination of two or more.

In the present invention, in the case of a powder detergent which is a preferred embodiment, whether or not component b) has a demulsification action is judged according to a method described in the Examples set forth below. In the case of products other than powder detergents, component b) may be used in an appropriate amount in place of enzymes described later.

The preferable combination of component b) and an emulsification action substance to be demulsified by component b) includes cationated cellulose or methyl cellulose when component b) is cellulase; sodium salt of casein when component b) is protease; an esterified processed starch or a sucrose fatty ester when component b) is amylase; and sodium salt of casein or a sucrose fatty ester when component b) is an alkali, depending upon the structure and feature of the emulsification action substance. Among them, it is preferable that component b) is cellulase and the emulsification action substance is cationated cellulose or methyl cellulose, or that component b) is protease and the emulsification action substance is sodium salt of casein.

It is necessary that the amount of component b) is a concentration required for the demulsification of the emulsification action substance in component a) upon use. The optimum range thereof varies depending on the use embodiment (concentration, time and the like) of the manufactured articles, the strength of an emulsion constituting component a), and the demulsification abilities (enzymatic activity, dissociation strength and the like) of component b). Samples having changed formulation amounts of component b) may be actually prepared, and the desired formulation amount can be determined by the sensory evaluation based on the generation of fragrance during dissolution, fragrance-keeping property and the like. For instance, in the case of a powder detergent which is a preferred embodiment of the present invention, a detergent is usually used in an amount of 20 to 40 g to 5 to 30 L of water (0.6 to 8 g/L). For instance, when sodium salt of casein, which is a protein-based emulsifying agent degraded and demulsified with protease, is used as an emulsification action substance and KAP13.1B (trade name, commercially available from Kao Corporation), which is a protease granule, is used as a demulsifying agent, it is preferable that the demulsifying agent is used in an amount of from 10 to 10000 parts by weight, more preferably from 100 to 1000 parts by weight based on 100 parts by weight of the emulsification action substance in the detergent, and the emulsification action substance is treated with the demulsifying agent in water.

In addition, in the present invention, “treating component a) with component b)” refers to generating a situation in which component a) and component b) are substantially contacted with each other so that component b) affects component a). The process includes, for instance, a process including the step of dissolving both component a) and component b) in a medium such as water; a process including the step of penetrating component a) with component b) in the form of a gas or a liquid in a case where component a) is in the form of a solid; and the like. In the case where both component a) and component b) are in the form of a solid such as a powder and there is substantially no possibility of demulsification taking place during storage when both components are combined, the process includes a process including the steps of previously blending both of the components into a single composition containing component a) and component b), and dissolving the composition in an appropriate medium upon use. Usually, the process of making the components into a single composition is a preferred process for use, from the viewpoint of easy handling. Among the embodiments mentioned above, an even more preferable application example is a laundry powder detergent. Since the feature of the present invention resides in that the perfume is efficiently released to generate fragrance when dissolved in water, the more preferable embodiment is a powder detergent used mainly for hand-washing laundry. For instance, when the feature is used to generate fragrance during hand-washing laundry, use of a highly volatile perfume such as limonene as the perfume is very preferable, since fragrance generation is quickly obtained.

One of the main features of the present invention resides in the conversion of the state of perfume from an emulsified state into a free state in a situation where fragrance is exhibited. By carrying out this conversion, two functions, which are usually incompatible to each other, of maintaining a stable storage state without losing perfume by a mechanism such as dissipation or degradation during preparation and storage, and efficient generation or releasing of perfume during use can be both satisfied.

The perfume in an emulsified state has been known to have a low dissipation rate to an upper surface of the liquid. In the case of a powder detergent, adsorption of a perfume to a spin-dried cloth during washing is considered to be caused by hydrophobic adsorption according to the hydrophobicity of the perfume. Because of these mechanisms, when a perfume is in a stable emulsified state even when used, water is undesirably drained while the perfume components remain dispersed in water, thereby increasing the amount of the perfume components used ineffectively. As a result, problems such as a decrease in fragrance in use, and decrease in fragrance remaining on the spin-dried cloth may occur. Therefore, the present invention solves the problems as described above by treating an emulsified perfume with a demulsifying agent in during use, thereby positively breaking up the emulsified state of the emulsified perfume.

By using the process for releasing fragrance of the present invention having the constitution as described above as a perfuming method, manufactured articles such as various foods, detergents, cosmetics, and bathing agents each having storage stability for the fragrance and a higher degree of freedom in the selection of fragrances, and being excellent in perfume generation and perfume-keeping property upon use can be obtained.

In addition, the perfume composition of the present invention contains the above component a) and the above component b). The kinds and amount ratio of component a) and component b) may be the same as those described above.

The total content of component a) and component b) in the perfume composition of the present invention is preferably from 0.1 to 20% by weight, more preferably from 1 to 5% by weight from the viewpoint of the balance between functions inherently owned by the manufactured article and improvement in added values from the aspect of fragrance.

The perfume composition of the present invention may contain optional components depending upon its purpose of using the perfume composition. The above purpose includes, for instance, detergents such as powder detergents, bathing agents, foods such as powder soup and gum, cosmetics and the like, among which the detergents are preferable. The present invention also encompasses a detergent composition which is one embodiment of the perfume composition of the present invention. It is preferable that the perfume composition of the present invention is a powder or solid manufactured article such as a detergent, a solid bathing agent, a food or a beverage because its method of use may include the step of dissolving a powdery manufactured article upon use.

When the perfume composition of the present invention is used for a detergent composition, it is preferable that the detergent composition further contains one or more compounds selected from the group consisting of surfactants, alkalizing agents, water softening agents, polymers and enzymes as optional components.

The above demulsifying agent may serve as an optional component, and the optional component may serve as the demulsifying agent, so that they show an overlap in their functions in some cases.

The surfactant includes nonionic surfactants such as polyoxyalkylene alkyl (phenyl) ethers, and alkyl(polyalkylene) polyglycosides, anionic surfactants such as sulfuric acid esters of alcohols and alkylbenzenesulfonates, and, known surfactants usually used in detergents, such as cationic surfactants and amphoteric surfactants.

The alkalizing agent includes sodium carbonate, potassium carbonate, sodium hydrogencarbonate, sodium hydrogensulfate and the like.

The water softening agent includes zeolite, citrates, tripolyphosphates, amorphous silica derivatives, crystalline silicate compounds and the like.

The polymer includes acrylic acid polymers, acrylic acid-maleic acid copolymers, anti-redeposition agents such as carboxymethyl cellulose, and the like.

The enzyme includes alkali cellulases, alkali proteases, amylases, lipases, keratinases, esterases, cutinases and the like.

In addition, the above detergent composition may contain a dispersant, a defoaming agent, a salt strength-controlling agent, a cloth softening agent, a bleaching agent, a bleach activator, a fluorescent whitening agent or the like.

The total content of these optional components is preferably from 80 to 99.9% by weight, more preferably 95 to 99% by weight of the detergent composition from the viewpoint of obtaining a sufficient deterging action.

The perfume composition and the detergent composition of the present invention can be each prepared by adding and mixing the above component a), component b) and the above optional components when necessary by a known method.

In addition, the present invention has an advantage that the selection of fragrance design can be increased by carrying out direct perfuming or using a perfume-penetrated molded product to the above perfume composition, the above detergent composition, or in the above process for releasing fragrance according to the purposes for the manufactured articles to be manufactured, for instance, for the purpose of deodorizing the odor of a base material, and the like. Therefore, the present invention also provides a process for preparing a detergent composition including the step of carrying out direct perfuming to the above perfume composition or the above detergent composition.

Examples of the direct perfuming method include a process including the step of mixing component a), component b) and optional components by a known method with a perfume sprayed thereto by means of a spray or the like.

### EXAMPLES

The present invention will be described in further detail by means of the following examples, without intending to limit the scope of the present invention thereto.

(Evaluation Conditions)

Here, as to the judgment on whether or not the combination can be demulsified, it is difficult to prove the occurrence of a demulsification phenomenon in the form of an embodiment itself since the amount of the perfume formulated is usually 1% by weight or less, and the perfume has a very low concentration of several dozen ppm in a dissolution state upon use. Therefore, it is advantageous to appropriately concentrate main components including the perfume particles and components which are considered to be involved in demulsification of the perfume particles in the composition (specifically, materials which hinder the visual judgment, such as water-insoluble components, are not formulated), whereby the demulsification can be judged conveniently. Therefore, the method of judging the demulsification in the present invention will be described hereinbelow, and the results are described in each of the Examples and Comparative Examples.

(Method of Judging Demulsification)

In each of two 200-mL beakers, 100 g of an emulsion was prepared in a concentration of 0.05% by weight calculated as a perfume (the concentration being adjusted by adding water to the emulsion or perfume particles before spray-drying), and likewise in two 200 mL beakers, 100 g of water was furnished. The water temperature for each of the above-mentioned four beakers was controlled at 20° C., and water was stirred with a stirrer having a length of 30 mm, to an extent that a depth of swirl of half that of the liquid depth was formed. A demulsifying agent to be judged was supplied in a given amount into one of the emulsion-containing beakers and one of the water-containing beakers (Here, components other than the demulsifying agent were supplied as little as possible in order to prevent disturbance on absorbance since the extent of demulsification is determined by absorbance. In addition, although it is necessary to adjust the supplying amount depending on the concentration assumed in the actual manufactured article system, and the mechanism for demulsification, the supplying amount is in principle the maximum amount which can be added as a ratio to the perfume in the form of the manufactured article.).

After supplying the demulsifying agent, stirring was continued for 10 minutes. Thereafter, each one of the round-bottomed centrifuging tubes (inner diameter: 10 mm, depth: 80 mm) was charged with each liquid mixture in an amount of 6 g/tube, one liquid mixture per tube. The centrifugation was carried out with a centrifuge (commercially available from Hitachi Koki Co., Ltd., trade name: “CR22G Rotor RPR18-3”) under conditions of 1000 rpm for one minute. Next, a liquid mixture was collected from the central portion of the centrifuging tube in an amount of 0.35 mL per tube (collected at a position 30 mm above the deepest portion of the centrifuging tube. The emulsion is usually white-turbid and uniform. When demulsification takes place, a transparent layer is formed at the central portion by floating of a perfume, deposition of a degradation substance and the like, and this layer is collected. When collecting, careful attention should be paid so as not to collect the components floating in the upper layer or the precipitated components in the lower layer.). The absorbance of each collected liquid mixture was determined with a UV meter (commercially available from Shimadzu Corporation, UV-1700) at 600 nm. The demulsification index was calculated according to the following formula to judge the extent of demulsification. Those having a demulsification index of 0.3 or less were judged to be demulsified.
Demulsification Index=((A−D)−(C−D))/(B−D)
wherein:
A: absorbance when the above-mentioned procedures were carried out with supplying a demulsifying agent to an emulsion;
B: absorbance when the above-mentioned procedures were carried out without supplying a demulsifying agent to an emulsion;
C: absorbance when the above-mentioned procedures were carried out with supplying a demulsifying agent to water; and
D: absorbance when the above-mentioned procedures were carried out without supplying a demulsifying agent to water (usually, 0).

The supplying amount of the demulsifying agent in the case of a laundry powder detergent, which is one of the preferred embodiments of the present invention, will be illustrated hereinbelow. The judgment on the presence or absence of demulsification in the Examples given below was carried out on the basis of the following methods.

Evaluation 1: Demulsification with Protease

The amount 0.5 g of protease granules (“KAP13.1B” commercially available from Kao Corporation, 13.1 APU/g based on the unit (APU) determined by the method for determining the degradation activity against urea-modified hemoglobin described in paragraph [0029] of Japanese Patent No. 2750789) was added (the manufactured article was assumed to contain 0.05% by weight of a perfume and 0.5% by weight of “KAP13.1B”).

Evaluation 2: Demulsification with Cellulase

0.5 g of cellulase granules (“KAC-1500B” commercially available from Kao Corporation, 14000 KU/g based on the unit (KU) determined by the method for determining enzyme activity described in paragraph [0020] of Japanese Patent Laid-Open No. Hei 10-313859) was added (the manufactured article assumed to contain 0.05% by weight of a perfume and 0.5% by weight of “KAC-1500B”).

Evaluation 3: Demulsification with Alkali

0.03 g of sodium carbonate (“DENSE ASH” commercially available from Shikoku Kasei K.K.) was added (the manufactured article was assumed to contain 0.05% by weight of a perfume and 30% by weight of “DENSE ASH”; however, the amount of the latter component was reduced since it is the concentration (pH) that is believed to be important for the action mechanism of an alkali.).

As an overall judgment, those having a calculated value according to the above calculation formula of 0.3 or more in any one of the evaluation methods was judged “negative”, and those having a calculated value of less than 0.3 in any one of the evaluation methods was judged “positive.”

(Process for Preparing Perfume Particles)

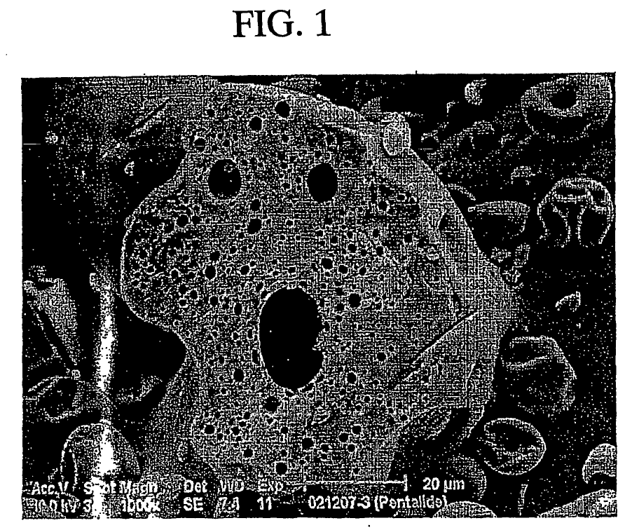

A perfume, an emulsifying agent (emulsification active substance), a matrix-forming agent and water were each weighed in a ratio shown in Table 1 to make up a total amount of 4000 g. The components other than the perfume were placed into an 8 L vessel, and mixed at a rotational speed of 2000 r/m for 30 minutes by a laboratory homomixer (commercially available from Tokushu Kika Kogyo Co., Ltd., “ROBOMICS” (registered trade mark)) to dissolve the components. Next, the perfume was added thereto, and the mixture was treated at 10000 r/m for 1 hour to form an emulsion. All emulsions were emulsions prepared by emulsifying into oil droplets having a size of about 2 μm, and were stable emulsions which did not cause any separation after allowing the emulsion to stand for 1 hour. The resulting emulsion was fed to a spray-drying tower at a rate of 100 g/min, and microgranulated by a binary fluid nozzle, and dried by feeding hot air of 120° C. The obtained dried product was separated and collected with a cyclone. As a result, particles having an average particle size of about 50 μm were obtained. A SEM image of the cross section of the perfume particle 6 is shown in FIG. 1.

(Detergent Base)

A powder detergent having the composition shown in Table 5 was used as a general laundry powder detergent (no-perfuming: having slight odors of the surfactant and enzyme).

(Direct Perfuming Method in Comparative Examples)

A perfume was sprayed onto the detergent composition (detergent base) shown in Table 5 with spray. Spraying and mixing were repeated, and perfuming was carried out until the intended amount was reached.

### Comparative Examples 1 to 3, Examples 1 and 2

Each of the detergent compositions shown in Table 2 was obtained by using perfume particles shown in Table 1. The odor of the detergent composition was evaluated in two stages; one is the odor of the powder detergent itself, and the other is the fragrance of the cloth after completion of washing, rinsing and spin-drying processes in a washing machine (herein referred to as “spin-dried cloth” in some cases). It can be seen from the results that the odor of the powder detergent itself is significantly suppressed and that the dissipated amount of the perfume is small in all cases using any perfume particles except for Comparative Example 1. In addition, it can be seen that the compositions (Examples 1 and 2) containing a combination to be demulsified according to the present invention efficiently release the fragrance of the perfumes formulated, without differing from that of the direct perfuming product, while the compositions being emulsified perfumes are excellent in storage stability, contrary to that the fragrance of the spin-dried cloth decreases in Comparative Examples 2 and 3.

### Comparative Examples 4 and 5, Examples 3 and 4

The evaluation results when the kind of perfume was changed are shown in Table 3. In the direct perfuming products shown in Comparative Examples 4 and 5, the fragrance is found to lower during storage, because of dissipation in the case of limonene, which is a perfume of high volatility, and degradation in the case of pentalide, which is a perfume of lower alkali resistance. In contrast, in Examples 3 and 4 each containing a combination of the perfume particles and the demulsifying agent according to the present invention, the fragrance is unchangeably exhibited on the spin-dried cloths after the storage of the detergent compositions. Even in the case of perfumes which have been conventionally difficult to use, the properties can be satisfactorily exhibited. Therefore, it can be seen that the perfume composition of the present invention is also an excellent technique even in the aspect of flexibility of using different kinds of perfume.

### Comparative Examples 6 to 9, Examples 5 and 6

The evaluation results when the direct perfuming is carried out to the composition of the present invention are shown in Table 4. It can be seen from the results that since the process for releasing perfume of the present invention is a process of efficiently releasing perfume upon use while releasing only little perfume during storage, the fragrance of the spin-dried cloth (adsorption onto clothes) can be designed during the wash, without being limited by change of the odor of the powder detergent itself. Therefore, it can be seen that the present invention is a technique capable of designing a variety of perfume matching one's life style by a combination with the properties (kind, volatility and the like of perfume) of the perfume itself.

TABLE 1

| | Perfume | Perfume | Perfume | Perfume | Perfume | Perfume |
|---|---|---|---|---|---|---|
| | Particle 1 | Particle 2 | Particle 3 | Particle 4 | Particle 5 | Particle 6 |
| Kind of Perfume | Formulation A¹⁾ | Formulation A¹⁾ | Formulation A¹⁾ | Formulation A¹⁾ | Formulation B³⁾ | Formulation C³⁾ |
| Kind of Emulsifying Agent | Gum Arabic²⁾ | Lipophilic | Na salt of | Cationated | Cationated | Cationated |
| | | Starch³⁾ | Casein⁴⁾ | Hydroxyethyl | Hydroxyethyl | Hydroxyethyl |
| | | | | Cellulose | Cellulose | Cellulose |
| Composition (% by wt.) | | | | | | |
| Perfume | 4 | 4 | 4 | 4 | 4 | 4 |
| Emulsifying Agent | 4 | 4 | 4 | 0.1 | 0.1 | 0.1 |
| Matrix-Forming Agent⁵⁾ | 32 | 32 | 32 | 35.9 | 35.9 | 35.9 |
| Water | 60 | 60 | 60 | 60 | 60 | 60 |
| Total | 100 | 100 | 100 | 100 | 100 | 100 |
| Judgment of Emulsification⁶⁾ | | | | | | |
| Emulsion (−) | 0.12 | 0.13 | 0.18 | 0.09 | — | — |
| Evaluation 1: KAP (−) | 1.8 | 1.1 | 0.0 | 0.0 | — | — |
| Evaluation 2: KAC (−) | 0.6 | 0.5 | 0.8 | 0.0 | — | — |
| Evaluation 3: Alkali (−) | 0.9 | 0.8 | 1.0 | 0.8 | — | — |
| Overall Judgment | Negative | Negative | Positive | Positive | Positive | Positive |

¹⁾Formulated Perfume A: Floral-based formulated perfume (degree of volatilization: medium to low);
²⁾Gum arabic: Reagent “gum arabic” commercially available from Kishida Kagaku K.K.
³⁾Perfume B: Limonene (orange-based, degree of volatilization: high); Perfume C: Pentalide (musk-based, degree of volatilization: low); Lipophilic Starch: commercially available from Matsutani Kagaku Kogyo K.K. under the trade name of “Emulstar 30A”
⁴⁾Na salt of Casein: commercially available from Saneigen FFI K.K. under the trade name of “Casein Natrium”
⁵⁾Matrix-Forming Agent: Maltodextrin (Matsutani Kagaku Kogyo K.K. under the trade name of “Pinedex #2”)
⁶⁾Judgment made by the method for judging demulsification in detergent (those having negative calculated values were considered as 0.)
Cationated Hydroxyethyl Cellulose: commercially available from Kao Corporation under the trade name of “POISE C-80M”

TABLE 2

| | Comp. | Comp. | Comp. | | |
|---|---|---|---|---|---|
| | Ex. 1 | Ex. 2 | Ex. 3 | Ex. 1 | Ex. 2 |
| Kind | | | | | |
| Detergent | Deter- | Deter- | Deter- | Deter- | Deter- |
| Base Material | gent | gent | gent | gent | gent |
| | Base | Base | Base | Base | Base |
| Perfume | — | Perfume | Perfume | Perfume | Perfume |
| Particles | | Parti- | Parti- | Parti- | Parti- |
| | | cle 1 | cle 2 | cle 3 | cle 4 |
| Kind of Perfume | Formula- | — | — | — | — |
| for Direct | tion A | | | | |
| Perfuming | | | | | |
| Amount Perfumed | | | | | |
| (as Perfume) | | | | | |
| Perfume Particles | | 0.045 | 0.045 | 0.045 | 0.045 |
| (% by weight, | | | | | |
| ratio to detergent | | | | | |
| base material) | | | | | |
| Direct Perfuming | 0.045 | — | — | — | — |
| (% by weight, | | | | | |
| ratio to detergent | | | | | |
| base material) | | | | | |
| Strength of | | | | | |
| Fragrance¹⁾ | | | | | |
| Odor of Powder | 3.0 | 1.0 | 1.0 | 1.0 | 1.0 |
| Detergent | | | | | |
| Fragrance of | 3.0 | 1.3 | 1.7 | 3.3 | 3.0 |
| Spin-Dried | | | | | |
| Cloth | | | | | |

¹⁾Strength of Fragrance: On the basis of Comparative Example 1, those having notably stronger fragrance were ranked 1, those having slighter stronger fragrance were ranked 4, those having equivalent fragrance were ranked 3, and those having a weaker fragrance were ranked 2, and those having notably weaker fragrance were ranked 1, and an average of three specialist panelists were taken.
Since the test was a sensory evaluation in each state, those having the same evaluation numerals do not necessarily coincide in the strength of the fragrance between the detergent powder and the spin-dried cloth.

TABLE 3

| | Comp. | | Comp. | |
|---|---|---|---|---|
| | Ex. 4 | Ex. 3 | Ex. 5 | Ex. 4 |
| Kind | | | | |
| Detergent Base | Detergent | Detergent | Detergent | Detergent |
| Material | Base | Base | Base | Base |
| Perfume Particles | — | Perfume | — | Perfume |
| | | Particle 5 | | Particle 6 |
| Kind of Perfume for | Limonene | — | Pentalide | — |
| Direct Perfuming | | | | |
| Amount Perfumed (as | | | | |
| Perfume) | | | | |
| Perfume Particles | — | 0.2 | — | 0.2 |
| (% by weight, ratio | | | | |
| to detergent base | | | | |
| material) | | | | |
| Direct Perfuming | 0.2 | — | 0.2 | — |
| (% by weight, ratio | | | | |
| to detergent base | | | | |
| material) | | | | |
| Strength of Fragrance | | | | |
| Before Storage | | | | |
| Odor of Powder | 3.0 | 1.3 | 3.0 | 1.0 |
| Detergent | | | | |
| Fragrance of | 3.0 | 3.3 | 3.0 | 3.0 |
| Spin-Dried Cloth | | | | |
| Strength of Fragrance | | | | |
| After Storage | | | | |
| Odor of Powder | 2.0 | 1.0 | 2.0 | 1.0 |
| Detergent | | | | |
| Fragrance of | 1.3 | 3.0 | 1.0 | 2.7 |
| Spin-Dried Cloth | | | | |

Comp. Ex. 4, and Ex. 3: Evaluated on the basis of before the storage of Comp. Ex. 4;
Comp. Ex. 5, and Ex. 4: Evaluated on the basis of before the storage of Comp. Ex. 5;
Storage Conditions: 50° C. for 2 weeks in a bottle with a lid with slight aeration.
Since the test was a sensory evaluation in each state, those having the same evaluation numerals do not necessarily coincide in the strength of the fragrance between the detergent powder and the spin-dried cloth.

TABLE 4

| | Comp. Ex. 6 | Comp. Ex. 7 | Ex. 5 | Comp. Ex. 8 | Comp. Ex. 9 | Ex. 6 |
|---|---|---|---|---|---|---|
| Kind | | | | | | |
| Detergent Base Material | Detergent | Detergent | Detergent | Detergent | Detergent | Detergent |
| | Base | Base | Base | Base | Base | Base |
| Perfume Particles | — | — | Perfume | — | — | Perfume |
| | | | Particle 4 | | | Particle 5 |
| Kind of Perfume for | Formulation A | Formulation A | Formulation A | Formulation A | Formulation A | Formulation A |
| Direct Perfuming 1 | | | | | | |
| Kind of Perfume for | — | — | — | — | Limonene | — |
| Direct Perfuming 2 | | | | | | |
| Amount Perfumed (as Perfume) | | | | | | |
| Perfume Particles | — | — | 0.35 | — | — | 1.00 |
| (% by weight, ratio to | | | | | | |
| detergent base material) | | | | | | |
| Direct Perfuming 1 | 0.35 | 0.70 | 0.35 | 0.20 | 0.20 | 0.20 |
| (% by weight, ratio to | | | | | | |
| detergent base material) | | | | | | |
| Direct Perfuming 2 | — | — | — | — | 1.00 | — |
| (% by weight, ratio to | | | | | | |
| detergent base material) | | | | | | |
| Strength of Fragrance¹⁾ | | | | | | |
| Odor of Powder Detergent | Appropriately | Notably Strong | Appropriately | Appropriately | Notably | Appropriately |
| | Floral | Floral | Floral | Floral | Strong Citrus | Floral |
| Fragrance During Washing | Slightly | Slightly Strong | Slightly Strong | Slightly | Appropriately | Appropriately |
| | Floral | Floral | Floral | Floral | Citrus | Citrus |
| Fragrance of Spin-Dried Cloth | Very Little | Appropriately | Appropriately | Very Little | Slightly | Slightly |
| | Floral | Floral | Floral | Floral | Citrus | Citrus |

Order of Strength of Fragrance: Notably strong > slightly strong > appropriately > slightly > very little

TABLE 5

| | | |
|---|---|---|
| LAS | 13% | by weight |
| Nonionic Surfactant | 13% | by weight |
| Sodium Carbonate | 20% | by weight |
| Sodium Sulfate | 15% | by weight |
| Zeolite | 30% | by weight |
| Protease Granules¹⁾ | 0.3% | by weight |
| Cellulase Granules²⁾ | 0.2% | by weight |
| Others³⁾ | 8.5% | by weight |
| Total | 100.0% | by weight |

¹⁾commercially available from Kao Corporation under the trade name of “KAP13.1B”;
²⁾commercially available from Kao Corporation under the trade name of “KAC-1500B”;
³⁾others: dispersants, fluorescent whitening agents and the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A process for releasing fragrance comprising the step of treating
a) a perfume emulsified with one or more substances having emulsification actions, with
b) a demulsifying agent capable of demulsifying at least one of the substances having emulsification actions.

2. The process according to claim 1, wherein the demulsifying agent is at least one member selected from the group consisting of enzymes, alkalis, acids, electrolytes, and mixtures thereof.

3. A perfume composition comprising:
a) a perfume emulsified with one or more substances having emulsification actions, and
b) a demulsifying agent capable of demulsifying at least one of the substances having emulsification actions.

4. The perfume composition according to claim 3, wherein the demulsifying agent is at least one member selected from the group consisting of enzymes, alkalis, acids, electrolytes, and mixtures thereof.

5. A detergent composition comprising the perfume composition of claim 3.

6. The detergent composition according to claim 5, further comprising one or more members selected from the group consisting of surfactants, alkalizing agents, water softening agents, polymers, enzymes, and mixtures thereof.

7. A process for preparing a detergent composition comprising carrying out direct perfuming to the perfume composition of claim 3.

8. A process for preparing a detergent composition comprising carrying out direct perfuming to the detergent composition of claim 5.
